(19) United States
(12) Patent Application Publication
(10) Pub. No.: US 2022/0335364 A1
(43) Pub. Date: Oct. 20, 2022

(54) PERSONNEL ARRANGEMENT APPARATUS, AND ARRANGEMENT METHOD, AND PROGRAM

(71) Applicant: NIPPON TELEGRAPH AND TELEPHONE CORPORATION, Tokyo (JP)

(72) Inventors: Masahide TAKASUKA, Musashino-shi, Tokyo (JP); Hiroshi YOSHIDA, Musashino-shi, Tokyo (JP); Tomoko SHIBATA, Musashino-shi, Tokyo (JP)

(73) Assignee: NIPPON TELEGRAPH AND TELEPHONE CORPORATION, Tokyo (JP)

(21) Appl. No.: 17/764,320

(22) PCT Filed: Oct. 2, 2019
(86) PCT No.: PCT/JP2019/038833

§ 371 Date: Mar. 28, 2022

(51) Int. Cl. G06Q 10/06

(52) U.S. Cl. CPC G06Q 10/063118; G06Q 10/063114

(57) ABSTRACT

A human resource arrangement apparatus according to an embodiment includes: a first storage unit (14) that stores predetermined assignment information indicating a result of assigning human resources who process a plurality of types of tasks to each of the tasks; a second storage unit (14) that stores processing information including values indicating processing abilities of the human resources for each of the plurality of types of tasks, a generation section (111) that generates, for the tasks, assignment information indicating a result of assigning the human resources who process the tasks, based on the processing information stored in the second storage unit (14); a determination section (112) that determines whether the generated assignment information is proper, through comparison between the assignment information stored in the first storage unit (14) and the assignment information generated by the generation section (111); and a decision section (114) that decides, in accordance with a determination of the determination section (112) that the generated assignment information is proper, the processing information used by the generation section to generate the assignment information as proper processing information.

### TECHNICAL FIELD

Embodiments of the present invention relate to a human resource arrangement apparatus, an arrangement method, and a program.

### BACKGROUND ART

As a technique for automatically deciding arrangement of human resources for processing a plurality of tasks, a technique of PTL 1, for example, is known. According to the technique of PTL 1, arrangement of human resources is decided such that a time to finish all tasks is minimized, the number of human resources is minimized, and variations in total processing times for the tasks assigned to each human resource are minimized based on processing time information representing a processing time of the tasks for each human resource.

### CITATION LIST

### Patent Literature

PTL 1: JP 2017-211921 A

### SUMMARY OF THE INVENTION

### Technical Problem

However, the aforementioned processing time information used to decide the arrangement of human resources is a value arbitrarily determined by a decision-making person such as a person in charge of human resource arrangement or is a value determined based on results of tests conducted on each person in charge of the tasks, for example. Thus, there are variations in precision of the aforementioned processing time information. This may also affect certainty of the decision of the arrangement of the human resources.

In other words, it is not possible to accurately obtain information in accordance with processing abilities of the human resources who are in charge of work to assign appropriate human resources to the work.

The present invention was made by focusing on the aforementioned circumstances, and an object thereof is to provide a human resource arrangement apparatus, an arrangement method, and an arrangement program that enable information in accordance with processing abilities of human resources who are in charge of work to be accurately obtained to assign appropriate human resources to the work.

### Means for Solving the Problem

A human resource arrangement apparatus according to an aspect of the present invention includes: a first storage unit that stores predetermined assignment information indicating a result of assigning human resources who process a plurality of types of tasks to each of the tasks; a second storage unit that stores processing information including values indicating processing abilities of the human resources for each of the plurality of types of tasks; a generation section that generates, for the tasks, assignment information indicating a result of assigning the human resources who process the tasks based on the processing information stored in the second storage unit; a determination section that determines whether the generated assignment information is proper through comparison between the assignment information stored in the first storage unit and the assignment information generated by the generation section; and a decision section that decides, as proper processing information, in accordance with a determination pf the determination section that the generated assignment information is proper, processing information used by the generation section to generate the assignment information.

A human resource arrangement method according to an aspect of the present invention is a method at a human resource arrangement apparatus including a first storage unit that stores predetermined assignment information indicating a result of assigning human resources who process a plurality of types of tasks to each of the tasks and a second storage unit that stores processing information including values indicating processing abilities of the human resources for each of the plurality of types of tasks, the method including: generating, for the tasks, assignment information indicating a result of assigning the human resources who process the tasks based on the processing information stored in the second storage unit; determining whether the generated assignment information is proper through comparison between the assignment information stored in the first storage unit and the generated assignment information; and deciding, in accordance with a determination that the generated assignment information is proper, the processing information used to generate the assignment information as proper processing information.

### Effects of the Invention

According to the present invention, it is possible to accurately obtain information in accordance with processing abilities of human resources who are in charge of work in order to assign appropriate human resources to the work.

### BRIEF DESCRIPTION OF DRAWINGS

FIG. 1 is a diagram illustrating an application example of an arrangement apparatus according to an embodiment of the present invention.

FIG. 2 is a diagram illustrating an example of a procedure for the arrangement apparatus to obtain a cost table according to the embodiment of the present invention.

FIG. 3 is a flow chart illustrating an example of a procedure for processing operations at the arrangement apparatus according to the embodiment of the present invention.

FIG. 4 is a diagram illustrating an example of a procedure for the arrangement apparatus to update the cost table according to the embodiment of the present invention.

FIG. 5 is a diagram illustrating a first example of a result of comparison between assignment tables.

FIG. 6 is a diagram illustrating a second example of a result of comparison between assignment tables.

FIG. 7 is a diagram illustrating a first example of an output of a cost table.

FIG. 8 is a diagram illustrating the first example of the output of the cost table.

FIG. 9 is a diagram illustrating the first example of the output of the cost table.

FIG. 10 is a diagram illustrating the first example of the output of the cost table.

FIG. 11 is a diagram illustrating the first example of the output of the cost table.

FIG. 12 is a diagram illustrating a second example of the output of the cost table.

FIG. 13 is a diagram illustrating the second example of the output of the cost table.

FIG. 14 is a diagram illustrating the second example of the output of the cost table.

FIG. 15 is a diagram illustrating the second example of the output of the cost table.

FIG. 16 is a diagram illustrating the second example of the output of the cost table.

### DESCRIPTION OF EMBODIMENTS

Hereinafter, embodiments of the present invention will be described based on the drawings. A human resource arrangement apparatus according to an embodiment of the present invention decides an appropriate assignment table that defines a result of arranging human resources to each of a plurality of tasks. The tasks include, for example, construction work. Although the following description will be given on the assumption that the tasks are to carry out construction, the tasks are not limited to construction work.

For example, the arrangement apparatus searches for arrangement of optimal human resources by solving a predefined mathematical analysis model.

Specifically, the arrangement apparatus searches for a result of arranging human resources to minimize an evaluation value that varies depending on a skill value, which will be described later. After the arrangement apparatus searches for the result of arrangement, the arrangement apparatus displays an assignment table, which is a searched result of arranging human resources, on a display, for example.

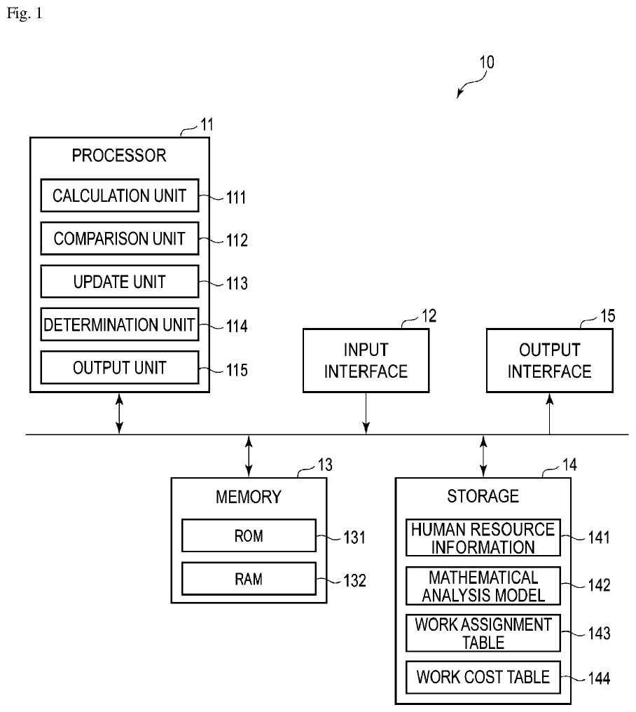

Hereinafter, the arrangement apparatus will be more specifically described. FIG. 1 is a diagram illustrating an application example of the arrangement apparatus according to an embodiment of the present invention.

The arrangement apparatus 10 has a hardware processor (hereinafter referred to as a processor) 11, an input interface 12, a memory 13, a storage 14, and an output interface 15. The storage 14 may also be referred to as a storage unit that stores each of predetermined assignment information indicating a result of assigning human resources who process a plurality of types of tasks to each of the tasks and processing information including values indicating processing abilities of the human resources for each of the plurality of types of tasks.
The processor 11, the input interface 12, the memory 13, the storage 14, and the output interface 15 are configured to be able to communicate with each other via a bus, for example. The arrangement apparatus 10 may be any of various terminal devices such as a personal computer, a smart phone, or a tablet terminal.

The processor 11 executes various kinds of processing of the arrangement apparatus 10. The processor 11 may be any of various processors such as a central processing unit (CPU), a microprocessing unit (MPU), or a graphics processing unit (GPU). Also, the processor 11 may be an application specific integrated circuit (ASIC), a field programmable gate array (FPGA), or the like. Also, the processor 11 may be configured with a plurality of CPUs or the like.

The processor 11 has a calculation unit 111, a comparison unit 112, an update unit 113, a decision unit 114, and an output unit 115.

The calculation unit 111 calculates an assignment table indicating appropriate arrangement of human resources by solving a mathematical analysis model using a cost table, which will be described later. The calculation unit 111 may also be referred to as a generation section that generates, for the tasks, assignment information indicating a result of assigning human resources who process the tasks based on processing information including values indicating processing abilities of the human resources for each of the plurality of types of tasks.

The comparison unit 112 compares the calculated assignment table with an assignment table prepared in advance, compares, for each element, a worker name that is a result of assigning a human resource to each element in the assignment table, and determines whether the worker names are the same. The comparison unit 112 may also be referred to as a determination section that compares the predetermined assignment information indicating the result of assigning the human resources who process the plurality of types of tasks to each of the tasks with the generated assignment information, thereby determining whether the generated assignment information is proper.

The update unit 113 updates the skill value set in the cost table used to generate the calculated assignment table in accordance with the result of the comparison at the comparison unit 112. The cost table is processing information including the values of the processing abilities of the human resources for each of the plurality of types of tasks.

The update unit 113 may also be referred to as an update section that updates, in accordance with a determination that the generated assignment information is not proper, the values indicating the processing abilities included in the processing information including the values indicating the processing abilities of the human resources for each of the plurality of types of tasks.

The decision unit 114 decides an optimal assignment table that follows a predetermined condition in a case in which there are a plurality of calculated assignment tables that conform or are similar to the assignment table prepared in advance as a result of the comparison. The decision unit 114 may also be referred to as a decision section that decides, in accordance with a determination that the generated assignment information is proper, the processing information used to generate the assignment information as proper processing information.

The output unit 115 outputs the result of arranging the human resources via the output interface 15. The calculation unit 111, the comparison unit 112, the update unit 113, the decision unit 114, and the output unit 115 are realized by software executed by the processor 11, for example. The calculation unit 111, the comparison unit 112, the update unit 113, the decision unit 114, and the output unit 115 may be realized by hardware that is different from the processor 11.

The input interface 12 is an interface for a decision-making person to provide various inputs to various arrangement apparatuses 10. The input interface 12 may include various input interfaces such as a touch panel, a mouse, and a keyboard. Also, the input interface 12 may include an input interface using sound.

The memory 13 is a memory used by the processor 11. The memory 13 includes a read only memory (ROM) 131 and a random access memory (RAM) 132. The ROM 131 stores a boot program such as a basic input output system (BIOS), for example. The RAM 132 temporarily holds various programs and data generated during execution of the various programs.

The storage 14 is, for example, a hard disk drive or a solid state drive. The storage 14 stores, for example, various application programs such as an operating system (OS) and a human resource arrangement program and various kinds of information used when the human resource arrangement program is executed.

In the embodiment, the storage 14 stores, as the various kinds of information used when the human resource arrangement program is executed, human resource information 141, a mathematical analysis model 142, a work assignment table 143, and a work cost table 144.

The human resource information 141 is information regarding human resources that are targets of arrangement.

The human resource information 141 may include a name, a number, or the like for identifying each human resource, for example.
The mathematical analysis model 142 includes an evaluation expression for performing calculation for arrangement of human resources.
The work assignment table 143 is, for example, information regarding a reference assignment table that is an arrangement table for arranging human resources created in the past, for example.

The work cost table 144 includes a skill value of each human resource for each task. The skill value is a numerical value based on a processing ability of each human resource for each task, for example, a time required for processing. In the present embodiment, a smaller skill value means a better value. The tasks are, for example, a plurality of works required for the human resources to carry out construction.

In the present embodiment, an optimal skill value of each human resource for each task is not known first, initial values of all skill values are set to one, the skill values are updated to larger values through processing, which will be described later, and optimal skill values can be eventually obtained.

Note the human resource information 141, the mathematical analysis model 142, the work assignment table 143, and the work cost table 144 may be stored in a storage device that is different from the storage 14 in the arrangement apparatus 10. In this case, the arrangement apparatus 10 acquires information from the storage device as needed.

The output interface 15 is an interface for outputting a result of arranging the human resources, for example. The output interface 15 includes a display such as a liquid crystal display, a printer, and the like.

Hereinafter, the calculation unit 111 will be further described. First, a configuration of the calculation unit 111 to search for arrangement of human resources will be described.

The calculation unit 111 is configured to search for a result of arranging the human resources to minimize a predetermined evaluation value. Hereinafter, such a result of arranging the human resources will be referred to as an optimal solution.
As a method for searching for the optimal solution, an active set method (quadratic programming), for example, is used. The active set method may not be used as the method for searching for the optimal solution. In other words, an arbitrary method by which it is possible to search for the result of arranging the human resources to minimize the evaluation value can be used.

The evaluation value is an evaluation value to evaluate an element on which priority should be placed in the arrangement of the human resources. In the present embodiment, the evaluation value is an evaluation value of a time required to perform construction processing, for example. The evaluation value is calculated based on a total of the aforementioned skill values for each task when some tasks are assigned to all the human resources that are targets of the arrangement.

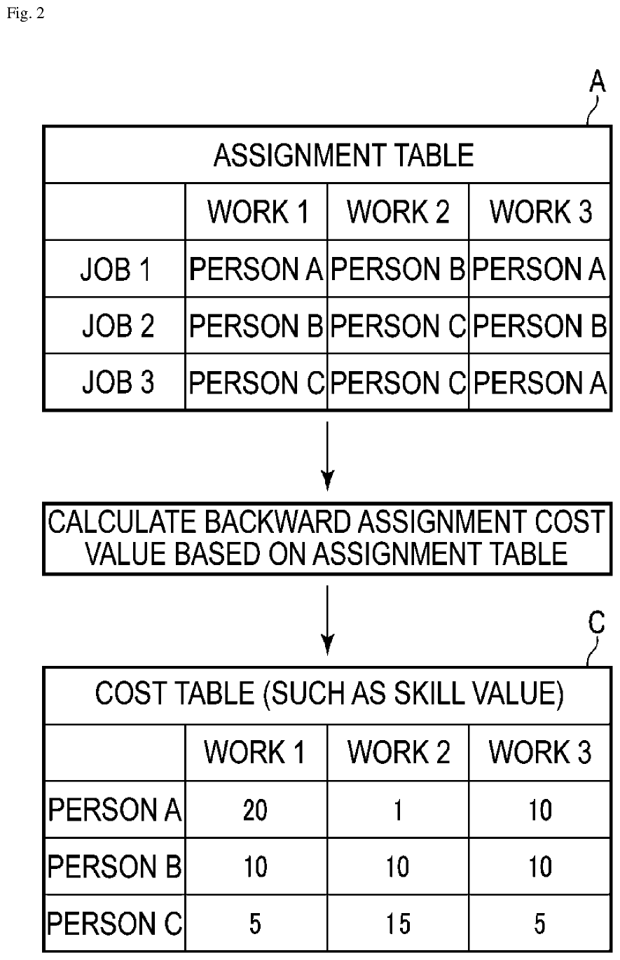

FIG. 2 is a diagram for explaining an example in which the arrangement apparatus obtains skill values in the cost table according to an embodiment of the present invention. As illustrated in FIG. 2, the arrangement apparatus according to an embodiment of the present invention has a function of calculating backward (searching for) optimal skill values in a cost table C from an assignment table A indicating assignment of human resources to each work related to each job by updating the skill values in the cost table, in which a time required by each human resource to perform each work to carry out a job is indicated as a skill value, a plurality of times, for example. In the present embodiment, the function is used in a scene in which it is desired to clarify the skill values when appropriate skill values in the cost table for performing assignment have not been identified or are obscure.

According to the present embodiment, an accurate cost table can be obtained from the assignment table even if the skill values in the cost table for performing assignment are not known.

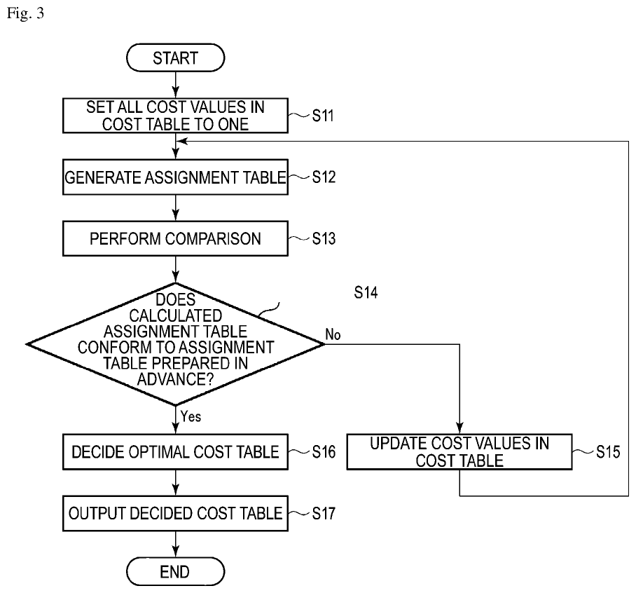

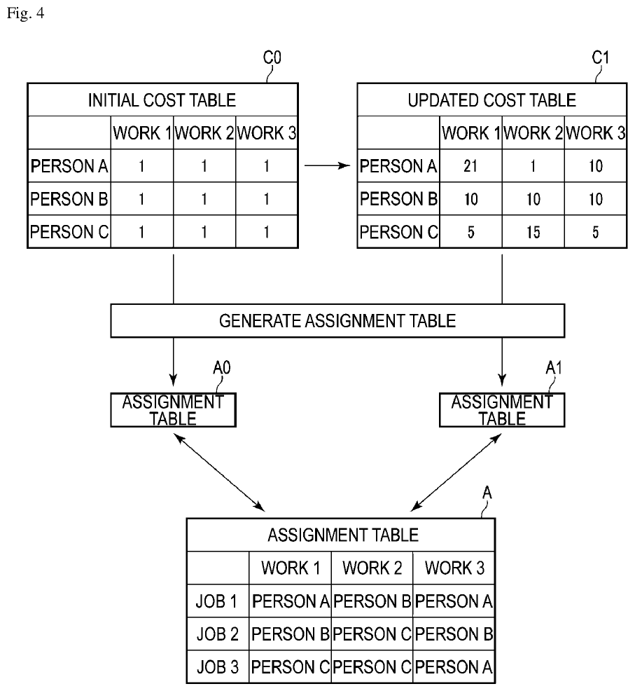

FIG. 3 is a flow chart illustrating an example of a procedure for processing operations at the arrangement apparatus according to an embodiment of the present invention. FIG. 4 is a diagram illustrating an example of a procedure at the arrangement apparatus to update the cost table according to an embodiment of the present invention.

First, the calculation unit 111 generates an initial cost table in which all skill values set in the cost table are set to one that is an initial value, for example, an initial cost table C0 illustrated in FIG. 4 (S11). The calculation unit 111 generates (calculates) an assignment table using the aforementioned mathematical analysis model, based on the cost table (S12).

Then, the comparison unit 112 compares, for each element, worker names that are results of assigning human resources to each element in assignment tables between the thus generated assignment table (hereinafter, also referred to as a generated assignment table) and the assignment table prepared by being stored in advance in the storage 14 (hereinafter, also referred to as a prior assignment table) and determines whether the worker names are the same (S13). The generated assignment table is, for example, a generated assignment table A0 illustrated in FIG. 4. The prior assignment table is, for example, a prior assignment table A illustrated in FIG. 4.

The number of types of elements in the assignment table are the number of combinations of jobs and works related to the jobs. In the example illustrated in FIG. 4, there are three types of jobs and three types of works, and there are thus nine types of elements in the assignment table. The same applies to the cost table.

In a case in which a worker name assigned as a person who is in charge of one element in the prior assignment table A, that is, a work related to a job is the same as a worker name assigned to the same type in the generated assignment table A0, that is, an element related to the same job and the same work in the comparison, for example, in a case in which a worker name assigned to an element corresponding to the column of “work 1” in the row of “job 1” is a “person A”, which is the same in the prior assignment table A and the generated assignment table A0, the comparison unit 112 sets a determination value “0” for the element. On the other hand, in a case in which the worker names are not the same, the comparison unit 112 sets a determination value “1” for the element. Such determination is repeated the number of times corresponding to the number of remaining elements.

Then, the decision unit 114 obtains, as a difference score, the value obtained by adding the set determination values for each element. The decision unit 114 regards the assignment result in the prior assignment table A and the assignment result in the generated assignment table A0 as substantially conforming to each other (Yes in S14) when the difference score is below a predetermined difference threshold value, for example, one, and obtains a determination result of “conforming”. The difference threshold value may be decided by a user's input operation.

In a case in which the determination result is “conforming”, the decision unit 114 decides the cost table used to generate the generated assignment table A0, in this case, the initial cost table C0, as an appropriate cost table (S16). The output unit 115 outputs the decided cost table via the output interface 15.

Also, in a case in which the determination result is not “conforming”, that is, in a case in which the determination result does not correspond to the aforementioned “substantially conforming” (No in S14), the update unit 113 updates at least one skill value in the current cost table to increase (S15). The calculation unit 111 generates a new generated assignment table A1 (S15→S12) using the aforementioned mathematical analysis model based on the cost table including the updated skill value.

Hereinafter, S12 to S15 described above are repeated until the determination result obtained by the comparison between the generated assignment table and the prior assignment table becomes “conforming”.

In the present embodiment, the arrangement apparatus may perform the update of the skill values in the cost table and the generation of the assignment table using the cost table including the updated skill values a plurality of times more even if the worker names are determined to “conform” to each other in the comparison between the prior assignment table and the one generated assignment table as described above, compare the generated assignment table with the prior assignment table, and decide an appropriate cost table based on a result of the comparison.

When a plurality of types of assignment tables correspond to the generated assignment tables for which determination of “conforming” has been made in the comparison, the decision unit 114 specifies any one type of generated assignment table using a predetermined condition and decides a cost table used to generate the specified generated assignment table as an appropriate cost table.

For the specification, the decision unit 114 acquires the cost table used to generate the assignment table for each of the plurality of types of generated assignment tables for which the determination of “conforming” has been made in the comparison. Then, the decision unit 114 calculates, for each cost table, a total of skill values related to each element in the acquired cost table and decides, as an appropriate cost table, a cost table with the smallest total from among the cost tables.

When there are a plurality of cost tables with the same totals of the aforementioned skill values, the decision unit 114 may calculate, for each corresponding cost table, dispersion of the skill values corresponding to each element set in the cost tables and decide a cost table with the largest dispersion as an appropriate cost table.

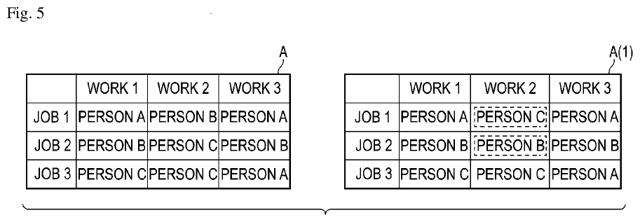

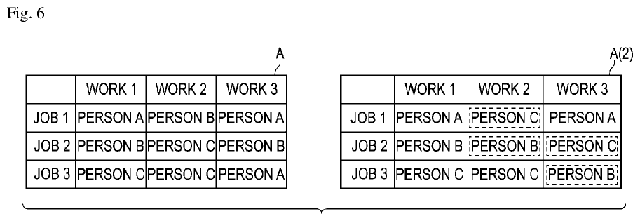

Next, specific examples of a difference score obtained through the comparison and determination based on the difference score and the difference threshold value will be described. FIG. 5 is a diagram illustrating a first example of a result of comparison between assignment tables. FIG. 6 is a diagram illustrating a second example of a result of comparison between assignment tables. First, in the example illustrated in FIG. 5, a result of comparing the prior assignment table A with a first assignment table A(1) generated from a certain cost table is illustrated.

As distinguished by the dashed line illustrated in FIG. 5, two assignment results, namely an assignment result for an element related to “Job 1” and “Work 2” and an assignment result for an element related to “Job 2” and “Work 2” are different from each other between the assignment tables according to the result of the comparison.

Thus, a difference score between the assignment tables is “2”. Here, on the assumption that the difference threshold value has been set to “1”, the difference score exceeds the difference threshold value. At this time, the decision unit 114 regards the assignment result based on the generated assignment table and the assignment result based on the prior assignment table as not corresponding to the above “substantially conforming” and determines the comparison result as “not conforming”.

Also, on the assumption that the difference threshold value has been set to “3” in the comparison between the same assignment tables illustrated in FIG. 5, the aforementioned difference score “2” is below the difference threshold value “3”. At this time, the decision unit 114 regards the assignment result based on the generated assignment table and the assignment result based on the prior assignment table as “substantially conforming” and determines the comparison result as “conforming”.

Next, in the example illustrated in FIG. 6, a result of comparing the prior assignment table A with a second assignment table A(2) generated from a certain cost table is illustrated. As distinguished by the dashed line illustrated in FIG. 6, four assignment results, namely (1) an assignment result for an element related to “Job 1” and “Work 2”, (2) an assignment result for an element related to “Job 2” and “Work 2”, (3) an assignment result for an element related to “Job 2” and “Work 3”, and (4) an assignment result for an element related to “Job 3” and “Work 3” are different from each other between the assignment tables according to the result of the comparison.

Thus, the difference score between the assignment tables is “4”. Here, on the assumption that the difference threshold value has been set to “3”, the difference score exceeds the difference threshold value. At this time, the decision unit 114 regards the assignment result based on the generated assignment table and the assignment result based on the prior assignment table as not corresponding to the above “substantially conforming” and determines the comparison result as “not conforming”.

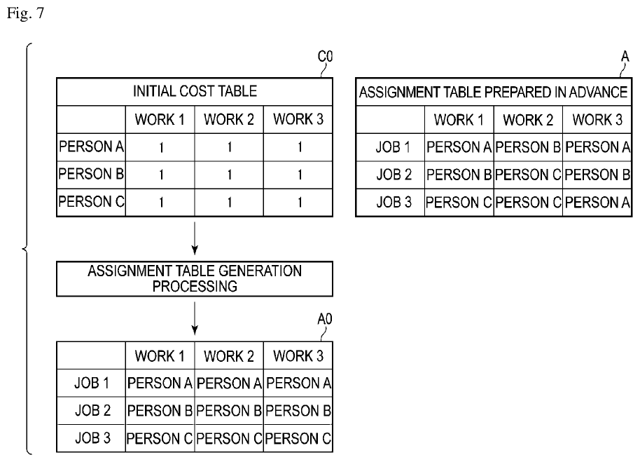

Next, a first example that results in an appropriate cost table being output using an initial cost table and a prior assignment table will be described. FIGS. 7 to 11 are diagrams illustrating the first example of the output of the cost table.

Here, it is assumed that update rules for skill values in the cost table are as follows. The rules are for an update method using a so-called infinite monkey theorem.

### Update Rules

A skill value of a person i for a work j is defined as xᵢⱼ.
The number of persons is defined as m, and the number of works is defined as 1.

```
      //initial value
i, j=1
for j<1
  for i<m
    xᵢⱼ=1
    i++
  end for
  j++
end for
//update of skill value
k=1
for k<=100
  t=m*1
  i, j=1
  k++
  for j<m
    for i<1
    x^{ij}:=k
    i++
  end for
  j++
end for
End of update rules
```

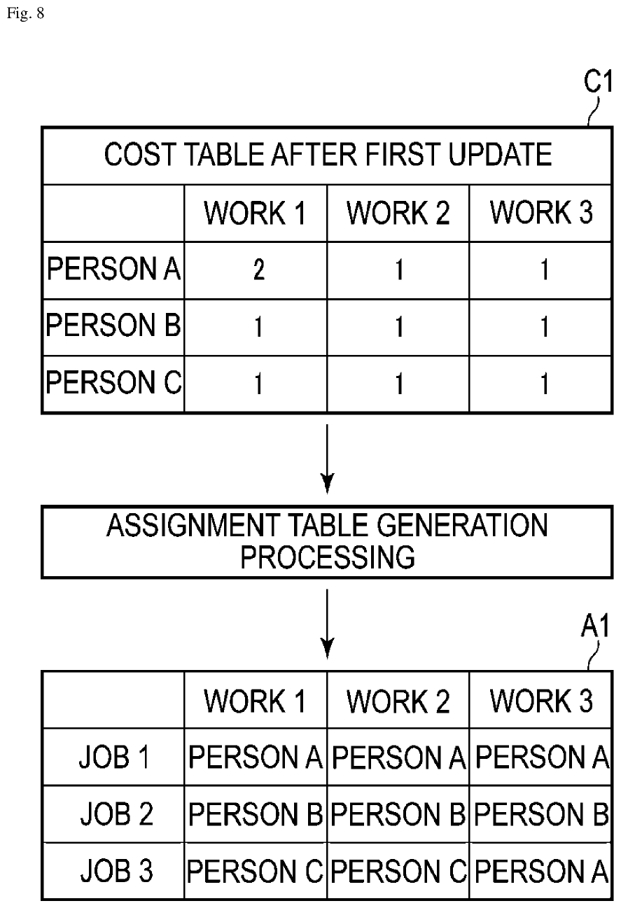

In the example illustrated in FIG. 7, human resources in the initial cost table C0 and the prior assignment table A are “Person A”, “Person B”, and “Person C”, and job names set in the prior assignment table A are “Job 1”, “Job 2”, and “Job 3”. Each job includes a plurality of types of works to carry out the job. In the example illustrated in FIG. 8, the work names set in the prior assignment table A are “Work 1”, “Work 2”, and “Work 3”.

In the example illustrated in FIG. 7, correspondences between combinations of job names and work names in the prior assignment table A and names of human resources assigned as persons who are in charge of the jobs and the works related to the combinations are as follows.

### Job 1:Work 1:Person A

### Job 1:Work 2:Person B

### Job 1:Work 3:Person A

### Job 2:Work 1:Person B

### Job 2:Work 2:Person C

### Job 2:Work 3:Person B

### Job 3:Work 1:Person C

### Job 3:Work 2:Person sC

### Job 3:Work 3:Person A

The calculation unit 111 generates the assignment table A0 from the initial cost table C0 illustrated in FIG. 7.

Correspondences between combinations of job names and work names in the generated assignment table A0 and names of human resources assigned as persons who are in charge of the jobs and works related to the combinations are as follows. When results of assigning human resources are difference from those in the prior assignment table A in the correspondences, the differences will be described together.

### Job 1:Work 1:Person A

Job 1:Work 2:Person A (different from prior assignment table A)

### Job 1:Work 3:Person A

### Job 2:Work 1:Person B

Job 2:Work 2:Person B (different from prior assignment table A)

### Job 2:Work 3:Person B

### Job 3:Work 1:Person C

### Job 3:Work 2:Person C

Job 3:Work 3:Person C (different from prior assignment table A)
Here, the determination result between the generated assignment table A0 and the prior assignment table A is regarded as “not conforming”.

At this time, a cost table C1 in which some of skill values in the initial cost table C0 used to generate the generated assignment table A0 have been updated as shown in FIG. 8 is generated, and the calculation unit 111 generates the assignment table A1 from the cost table C1 after the first update.

Correspondences between combinations of the job names and the work names in the generated assignment table A1 generated in this manner and names of human resources assigned as persons who are in charge of the jobs and the works related to the combinations are as follows.

### Job 1:Work 1:Person A

Job 1:Work 2:Person A (different from prior assignment table A)

### Job 1:Work 3:Person A

### Job 2:Work 1:Person B

Job 2:Work 2:Person B (different from prior assignment table A)

### Job 2:Work 3:Person B

### Job 3:Work 1:Person C

### Job 3:Work 2:Person C

### Job 3:Work 3:Person A

Here, the determination result between the generated assignment table A1 and the prior assignment table A is assumed to be “not conforming”.

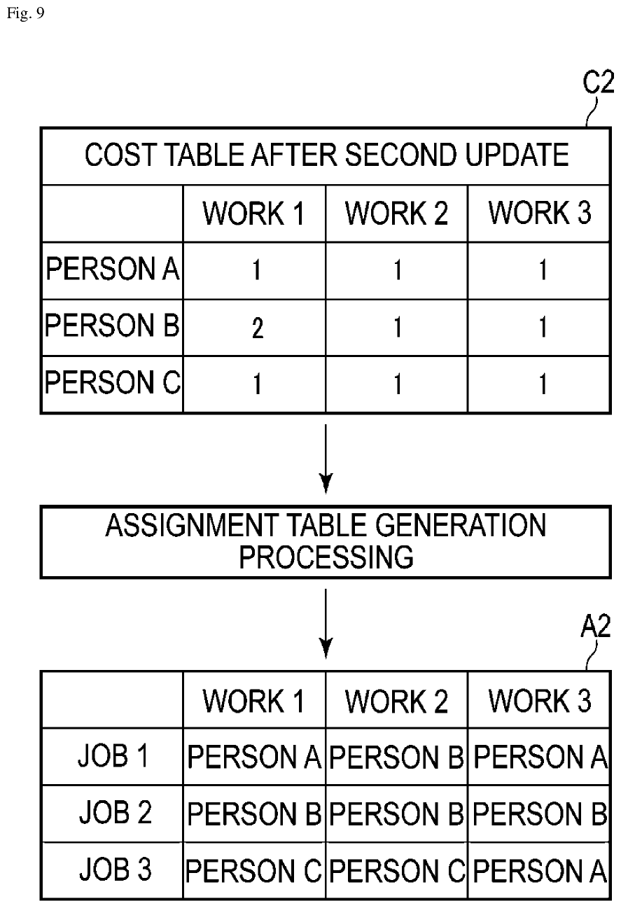

At this time, a cost table C2 in which some of skill values in the cost table C1 used to generate the generated assignment table A1 have been updated as illustrated in FIG. 9 is generated, and the calculation unit 111 generates an assignment table A2 from the cost table C2 after the second update.

Correspondences between combinations of job names and work names in the generated assignment table A2 generated in this manner and names of human resources assigned as persons who are in charge of the jobs and the works related to the combinations are as follows.

### Job 1:Work 1:Person A

### Job 1:Work 2:Person B

### Job 1:Work 3:Person A

### Job 2:Work 1:Person B

Job 2:Work 2:Person B (different from prior assignment table A)

### Job 2:Work 3:Person B

### Job 3:Work 1:Person C

### Job 3:Work 2:Person C

### Job 3:Work 3:Person A

Here, the determination result between the generated assignment table A2 and the prior assignment table A is assumed to be “not conforming”.

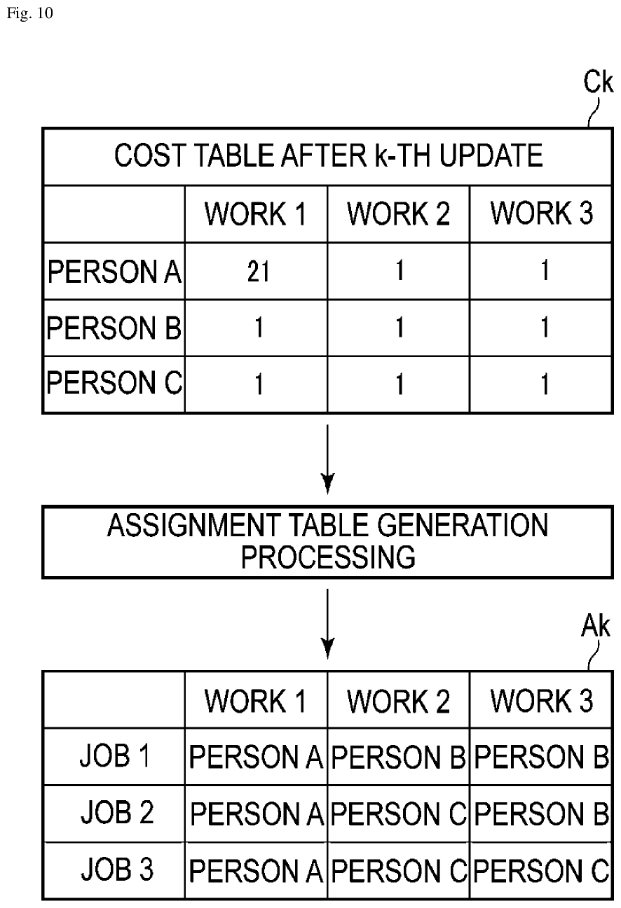

Then, a cost table Ck after k-th update is generated as illustrated in FIG. 10 after update of the skill values in the cost table C2 used to generate the generated assignment table A2 and the like, and the calculation unit 111 generates an assignment table Ak from the cost table Ck.

Correspondences between combinations of job names and work names in the generated assignment table Ak generated in this manner and assignment results that are names of human resources assigned as persons who are in charge of the jobs and the works related to the combinations are as follows.

### Job 1:Work 1:Person A

### Job 1:Work 2:Person B

Job 1:Work 3:Person B (different from prior assignment table A)
Job 2:Work 1:Person A (different from prior assignment table A)

### Job 2:Work 2:Person C

### Job 2:Work 3:Person B

Job 3:Work 1:Person A (different from prior assignment table A)

### Job 3:Work 2:Person C

Job 3:Work 3:Person C (different from prior assignment table A)

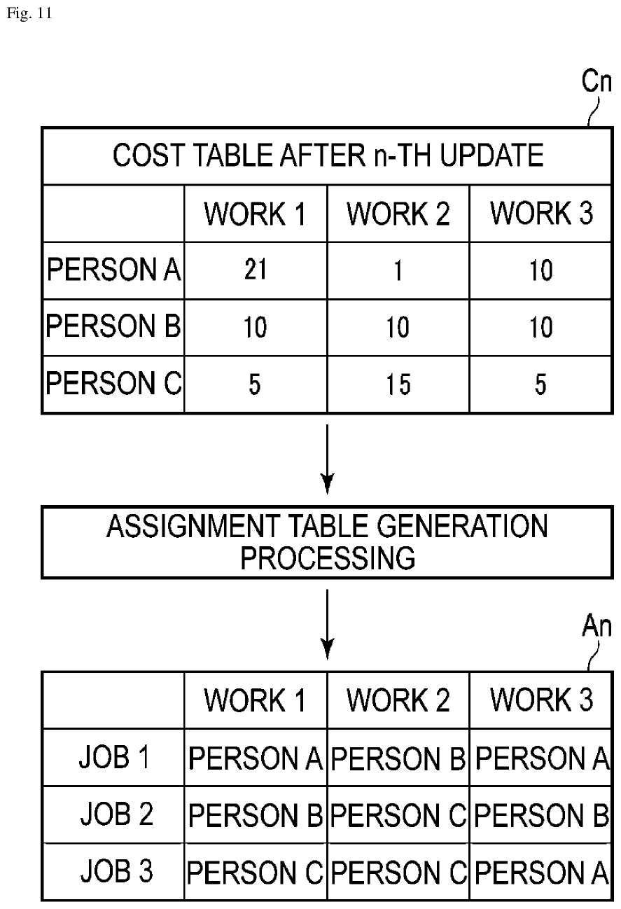

Then, a cost table Cn after n-th update is generated as illustrated in FIG. 11 after update of skill values in the cost table Ck used to generate the generated assignment table Ak and the like, and the calculation unit 111 generates an assignment table An from the cost table Cn. Because the result of assigning human resources in the generated assignment table An generated in this manner conforms to that in the prior assignment table A in regard to all elements, the determination result between the generated assignment table An and the prior assignment table A is regarded as “conforming”.

In other words, because it is possible to generate an assignment table that conforms to the prior assignment table A using the cost table Cn, the cost table Cn is decided as a cost table in which appropriate skill values have been set.

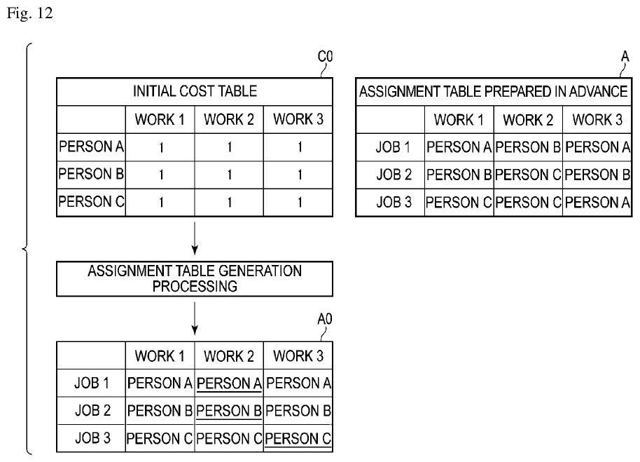

Next, a second example that results in an appropriate cost table being output using an initial cost table and a prior assignment table will be described. FIGS. 12 to 16 are diagrams illustrating the second example of the output of the cost table.

Here, update rules for skill values in the cost table are as follows.

Update Rules

A skill value of a person i for a work j is defined as xᵢⱼ.
The number of persons is defined as m, and the number of works is defined as 1.
When there are differences between assignment results in comparison between an assignment table prepared in advance and an assignment table generated from the cost table, a skill value in a cost table related to a work j of which a corresponding person i is in charge in the generated assignment table is incremented by one and updated, and the other skill values are not updated.

### End of Update Rules

For example, if an assignment result related to a certain job and a certain work is “Person B” in a generated assignment table, and an assignment result related to the same job and the same work is “Person A” in the prior assignment table, the skill value in the column corresponding to the same work in the row for “Person A” in the cost table used to generate the generated assignment table is incremented by one and updated.

The calculation unit 111 generates an assignment table A0 from the initial cost table C0 illustrated in FIG. 12. It is assumed that as a result of the comparison between the generated assignment table A0 generated in this manner and the prior assignment table A, assignment results at a total of three points, namely (1) an assignment result related to “Job 1:Work 2”, (2) an assignment result related to “Job 2:Work 2”, and (3) an assignment result related to “Job 3:Work 3” in the generated assignment table A0 are different from those in the prior assignment table A, and that the determination result between the generated assignment table A0 and the prior assignment table A is “not conforming”. In FIGS. 12 to 15, the different assignment results are distinguished with underlines.

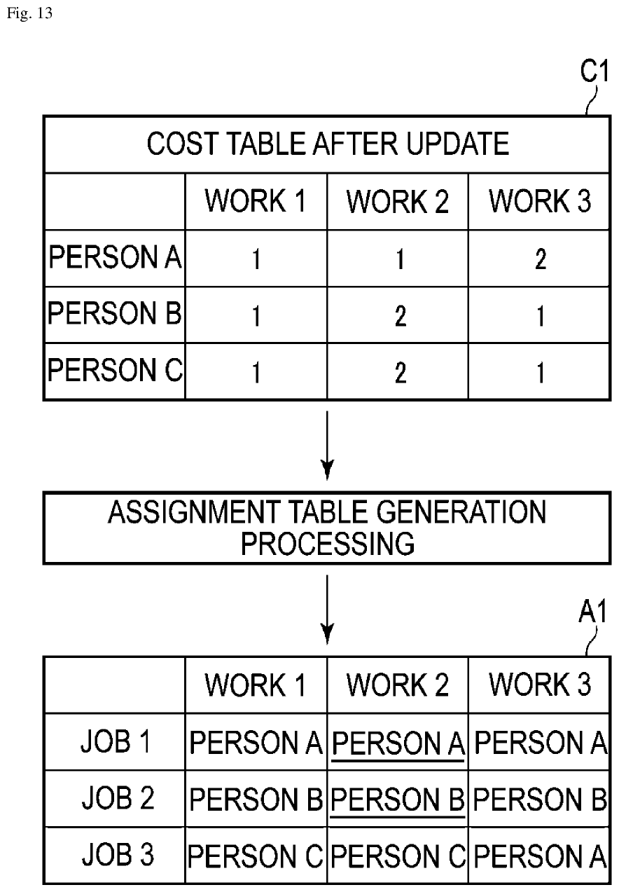

A cost table C1 after several updates is generated as illustrated in FIG. 13 after update of skill values in the cost table C0 used to generate the generated assignment table A0 in response to the differences and the like, and the calculation unit 111 generates an assignment table A1 from the cost table C1.

As distinguished with the underlines illustrated in FIG. 13, the result of assigning human resources in the generated assignment table A1 generated in this manner is different from that in the prior assignment table A in regard to two elements, and the determination result between the generated assignment table A1 and the prior assignment table A is regarded as “not conforming”.

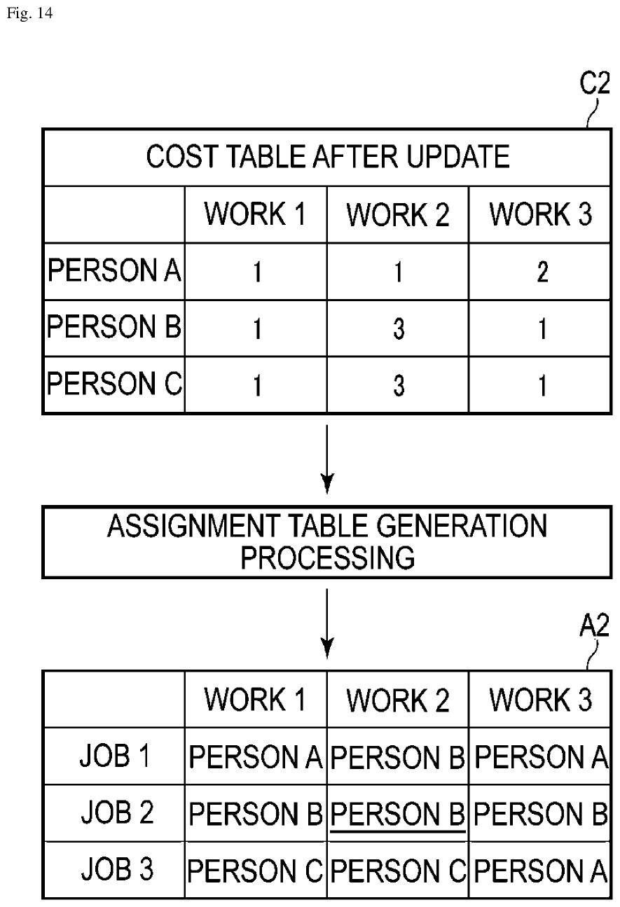

A cost table C2 after several updates is generated as illustrated in FIG. 14 after update of skill values in the cost table C1 used to generate the generated assignment table A1 in response to the determination, and the calculation unit 111 generates an assignment table A2 from the cost table C2. As distinguished with the underline illustrated in FIG. 14, the result of assigning human resources in the generated assignment table A2 generated in this manner is different from that in the prior assignment table A in regard to one element, and the determination result between the generated assignment table A2 and the prior assignment table A is regarded as “not conforming”.

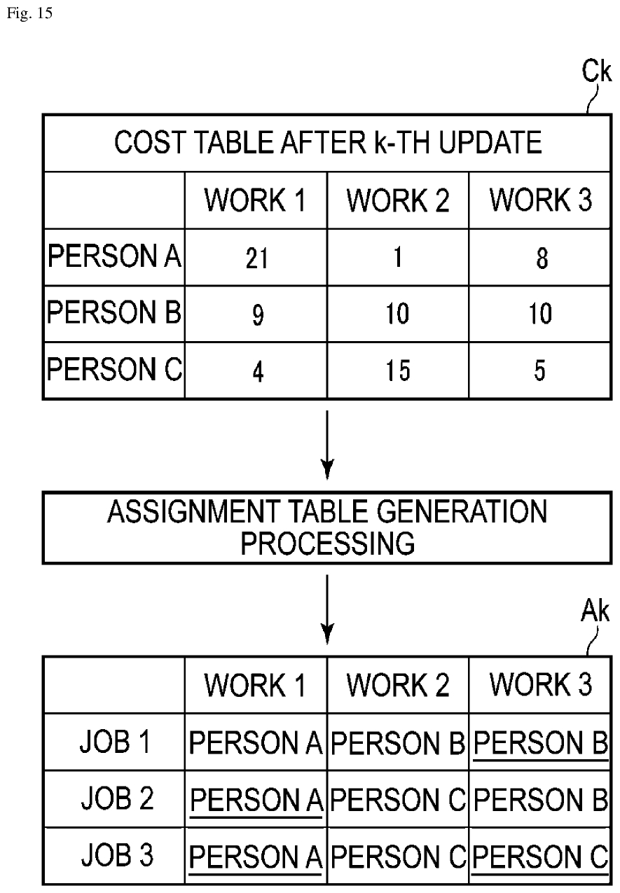

A cost table Ck after k-th update is generated as illustrated in FIG. 15 after update of skill values in the cost table C1 used to generate the generated assignment table A1 and the like in response to the determination, and the calculation unit 111 generates an assignment table Ak from the cost table Ck.

As distinguished with the underlines illustrated in FIG. 15, the result of assigning human resources in the generated assignment table Ak generated in this manner is different from that in the prior assignment table A in regard to four elements, and the determination result between the generated assignment table Ak and the prior assignment table A is regarded as “not conforming”.

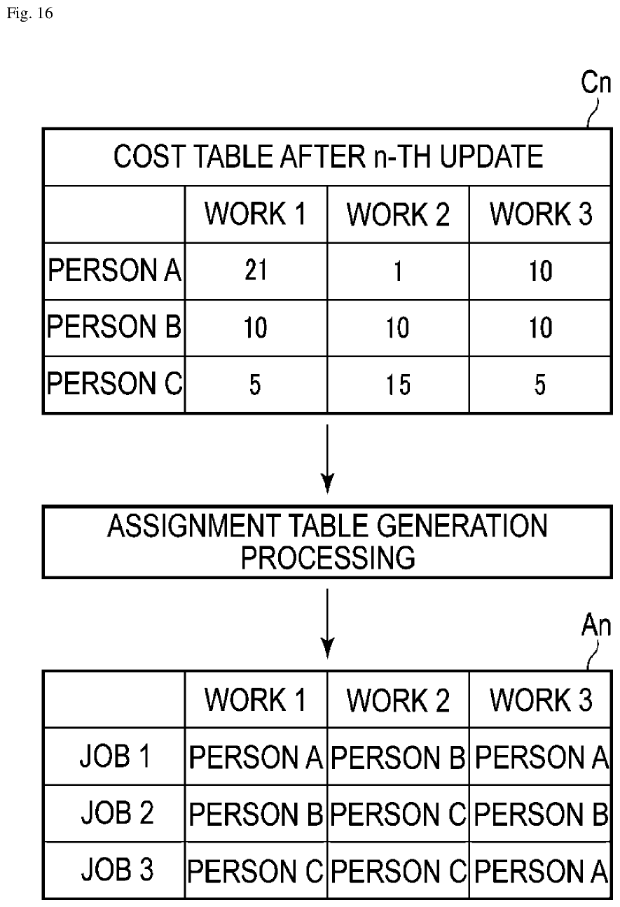

A cost table Cn after n-th update is generated as illustrated in FIG. 16 after update of skill values in the cost table Ck used to generate the generated assignment table Ak and the like in response to the determination, and the calculation unit 111 generates an assignment table An from the cost table Cn.

Because the result of assigning human resources in the generated assignment table An generated in this manner conforms to that in the prior assignment table A in regard to all elements, the determination result between the generated assignment table An and the prior assignment table A is regarded as “conforming”.

In other words, because it is possible to generate an assignment table that conforms to the prior assignment table A using the cost table Cn, the cost table Cn is decided as a cost table in which appropriate skill values have been set.

As described above, the arrangement apparatus according to the embodiment of the present invention updates skill values in the cost table in accordance with a result of comparing the generated assignment table based on the cost table with the prior assignment table using the initial cost table and the prior assignment table. Also, the arrangement apparatus according to an embodiment of the present invention is adapted such that when an assignment result based on the generated assignment table conforms to the assignment result based on the prior assignment table as a result of comparison between the generated assignment table based on the updated cost table and the prior assignment table, the arrangement apparatus decides the cost table, based on which the generated assignment table is generated at this time, as an appropriate cost table.

It is thus possible to accurately obtain information in accordance with processing abilities of human resources who are in charge of works to assign appropriate human resources to the works.

Also, a method described in each embodiment can be stored in a recording medium such as a magnetic disk (a Floppy (registered trademark) disk, a hard disk, or the like), an optical disc (a CD-ROM, a DVD, an MO, or the like), a semiconductor memory (a ROM, a RAM, a flash memory, or the like), for example, and can be transferred and distributed by a communication medium, as a program (a software unit) that a computing device (computer) can be caused to execute. Note that the program stored on the medium side includes a setting program for configuring, in the computer, the software unit (including not only an execution program but also a table and a data structure) that the calculator is caused to execute. A computer that realizes the present apparatus executes the aforementioned processing by loading the program recorded in the recording medium or constructing the software unit using the setting program in some cases and controlling operations using the software unit. Note that the recording medium referred to herein is not limited to a recording medium for distribution but also includes a storage medium such as a magnetic disk or a semiconductor memory provided inside the computer or a device connected thereto via a network.

It is to be noted that the present invention is not limited to the aforementioned embodiments and can be variously modified in the implementation stage without departing from the gist of the present invention. An appropriate combination of the embodiments can also be implemented, in which a combination of their effects can be obtained. Further, the above embodiments include various inventions, which can be designed by combining constituent elements selected from a plurality of constituent elements disclosed here. For example, a configuration in which some constituent elements are removed from all the constituent elements shown in the embodiments can be designed as the invention if the problems can be solved and the effects can be achieved.

### REFERENCE SIGNS LIST

10 Arrangement apparatus

111 Calculation unit

112 Comparison unit

113 Update unit

114 Decision unit

115 Output unit

141 Human resource information

142 Mathematical analysis model

143 Work assignment table

144 Work cost table

1. A human resource arrangement apparatus comprising:
a first storage unit configured to store predetermined assignment information indicating a result of assigning human resources who process a plurality of types of tasks to each of the tasks;
a second storage unit configured to store processing information including values indicating processing abilities of the human resources for each of the plurality of types of tasks;
a processor; and
a storage medium having computer program instructions stored thereon, when executed by the processor, perform to:
generate, for the tasks, assignment information indicating a result of assigning the human resources who process the tasks based on the processing information stored in the second storage unit;
determine whether the generated assignment information is proper through comparison between the assignment information stored in the first storage unit and the assignment information generated by the generation section; and
decide, as proper processing information, in accordance with a determination of the determination section determines that the generated assignment information is proper, processing information used by the generation section to generate the assignment information.

2. The human resource arrangement apparatus according to claim 1, wherein the computer program instructions further perform to
update, in accordance with a determination of the determination section that the generated assignment information is not proper, values indicating the processing abilities included in the processing information stored in the second storage unit,
re-generates, for the tasks, the assignment information indicating a result of assigning the human resources who process the tasks based on the updated processing information, and
determines whether the re-generated assignment information is proper through comparison between the assignment information stored in the first storage unit and the re-generated assignment information.

3. The human resource arrangement apparatus according to claim 2, wherein the computer program instructions further perform to
generates, for each of a plurality of items of the processing information generated as a result of the update at the update section and including different values indicating the processing abilities, the assignment information based on the processing information,
determines whether the generated assignment information conforms or is similar to the assignment information stored in the first storage unit for each of the items of the assignment information generated for each of the plurality of items of the processing information, and
calculates, in accordance with a determination of the determination section that a plurality of items of the assignment information out of the assignment information generated for each of the plurality of items of the processing information conform or are similar to each other, statistical values of the values indicating the processing abilities included in the processing information used to generate the assignment information and decides the proper processing information based on the statistical values.)

4. A human resource arrangement method at a human resource arrangement apparatus including a first storage unit configured to store predetermined assignment information indicating a result of assigning human resources who process a plurality of types of tasks to each of the tasks and a second storage unit configured to store processing information including values indicating processing abilities of the human resources for each of the plurality of types of tasks, the method comprising:
generating, for the tasks, assignment information indicating a result of assigning the human resources who process the tasks based on the processing information stored in the second storage unit;
determining whether the generated assignment information is proper through comparison between the assignment information stored in the first storage unit and the generated assignment information; and
deciding, in accordance with a determination that the generated assignment information is proper, the processing information used to generate the assignment information as proper processing information.

5. The human resource arrangement method according to claim 4, further comprising:
updating the values indicating, in accordance with a determination that the generated assignment information is not proper, the processing abilities included in the processing information stored in the second storage unit,
wherein the generating of the assignment information includes re-generating, for the tasks, the assignment information indicating the result of assigning the human resources who process the tasks based on the updated processing information, and
the determining of whether the generated assignment information is proper includes determining whether the re-generated assignment information is proper through comparison between the assignment information stored in the first storage unit and the re-generated assignment information.

6. The human resource arrangement method according to claim 5,
wherein the generating of the assignment information includes generating, for each of a plurality of items of the processing information generated as a result of the update and including different values indicating the processing abilities, the assignment information based on the processing information,
the determining of whether the generated assignment information is proper includes determining, for each item of the assignment information generated for each of the plurality of items of the processing information, whether the generated assignment information conforms or is similar to the assignment information stored in the first storage unit, and
the deciding of the processing information used to generate the assignment information as proper processing information includes, in accordance with a determination that the plurality of items of assignment information out of the assignment information generated for each of the plurality of items of the processing information conform or be similar to each other, calculating statistical values of the values indicating the processing abilities included in the processing information used to generate the assignment information and deciding the proper processing information based on the statistical values.

7. A human resource arrangement processing program for causing a processor included in the human resource arrangement apparatus according to claim 1 to perform the processing of the human resource arrangement apparatus.
